(19) United States
(12) Patent Application Publication
(10) Pub. No.: US 2002/0184863 A1
(43) Pub. Date: Dec. 12, 2002

(54) Enbloc device for filtering the intake air of combustion engines

(76) Inventor: Gaetano Bergami, Medicina (IT)

Correspondence Address: William J. Sapone, Esq., Coleman Sudol Sapone P.C., 708 Third Avenue, New York, NY, 10017, US

(21) Appl. No.: 10/166,861

(22) Filed: Jun. 11, 2002

(30) Foreign Application Priority Data
Jun. 11, 2001 (IT) B02001A000369

(51) Int. Cl. B01D 46/00

(52) U.S. Cl. 55/486; 55/497; 55/502

(57) ABSTRACT

An enbloc device for filtering the intake air of internal combustion engines includes a filtering element (2) corrugated and peripherally fixed to a support mean (9).

This latter includes at least a first element (3) and a second element (4) respectively having shaped edges, first (21) and second (22), for reproducing the peripheral profile of the filtering element (2) and fixed to this latter in a single block.

### DESCRIPTION OF THE INVENTION

The present invention relates to filters for filtering the intake air of combustion engines. Particularly the present invention refers to an enbloc device for filtering the intake air of internal combustion, supercharged and aspirated, engines especially with high performances and fit for being assembled into a related housing carried out in an intake duct.

In the automotive field, the air filtering has particular importance since avoids the inlet of foreign matter inside the engine.

There are known cylindrical or conical air filters fit to be fixed to an intake duct or enclosed into a casing with inlet openings for the ambient air and connected to a related intake duct.

The main drawback of the cylindrical or conical air filters consists in their high weight causing excessive stress of the related connections, with disconnection and failures risks, and increases the weight/power ratio reducing the performances of the vehicle in which said filters arc installed.

Other drawback consists in theirs wide dimensions limiting the installation in several engine compartments.

There are known filtering devices with a flat shape having an undulated filtering element, generally made of polyester or paper, fixed to a heavy support fit to strengthen the filter and to airtight mate the walls of the related housing.

A polyurethan molding including the perimetric portion of the filtering element generally carries out the support.

The main drawback of said known flattened filters consists in that the support must have wide dimensions to give enough mechanical resistance to the filter, so being excessively heavy and in that the useful surface of the filtering element is inadequate because this latter must be moderately corrugated for allowing the diffusion of the polyurethan melted material between the interstices of the corrugated filtering device.

Another drawback consists in that the high reduction of the air flow through the filter caused by the high resistance of the polyester or paper filtering elements which further have the so-called “sponge effect” that causes technical problems to the sports engines due to humidity.

A further drawback consists in that the polyurethan support cannot withstand temperatures greater than 90° C., achievable inside the high performance engines.

The main object of the present invention is to propose an enbloc device for filtering the intake air of internal combustion engines extremely strong and reliable, suitable to withstand typical mechanical stress of the race vehicles and temperatures up to about 250° C., and at the same time light and fit for reducing the air flow resistances

Further object of the present invention is to propose a device without the sponge effect and having a high filtering value of the air.

Another object is to propose also a device having limited external dimensions and a wide surface of the filtering element.

The objects above-mentioned are achieved according with the content of the claims. The characteristics of the invention are underlined in the following with particular reference with the attached drawings, in which:

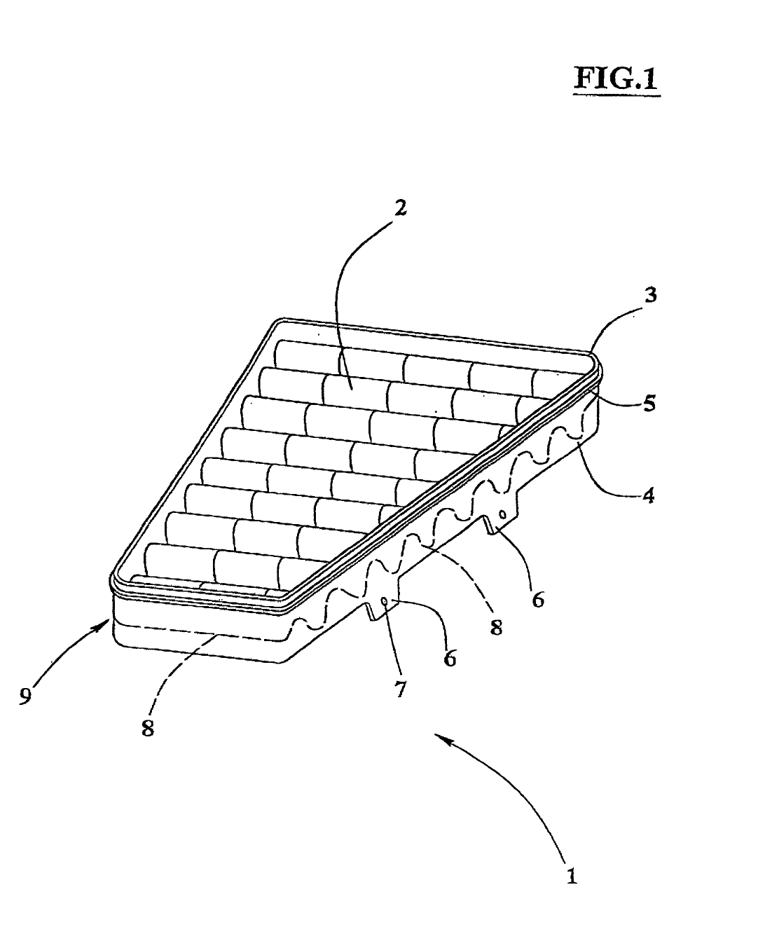

FIG. 1 shows an axonometric view of the device object of the present invention;

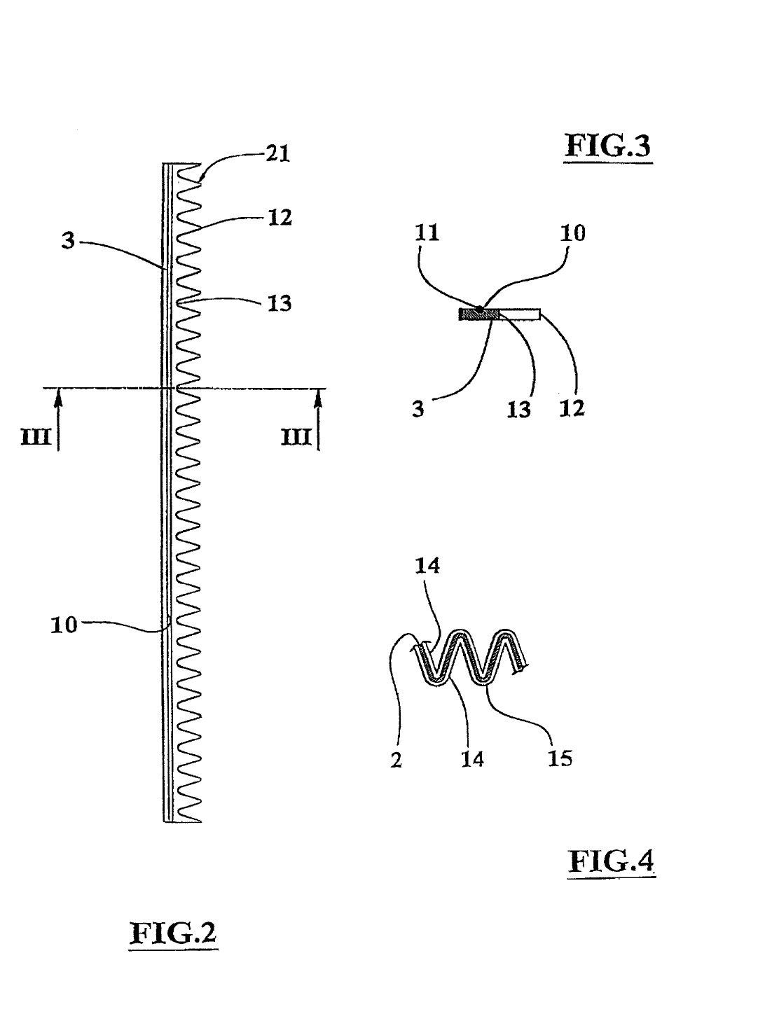

FIG. 2 shows 1 a side view of a first element of the FIG. 1 device;

FIG. 3 shows a section view according to the plan III-III of FIG. 2;

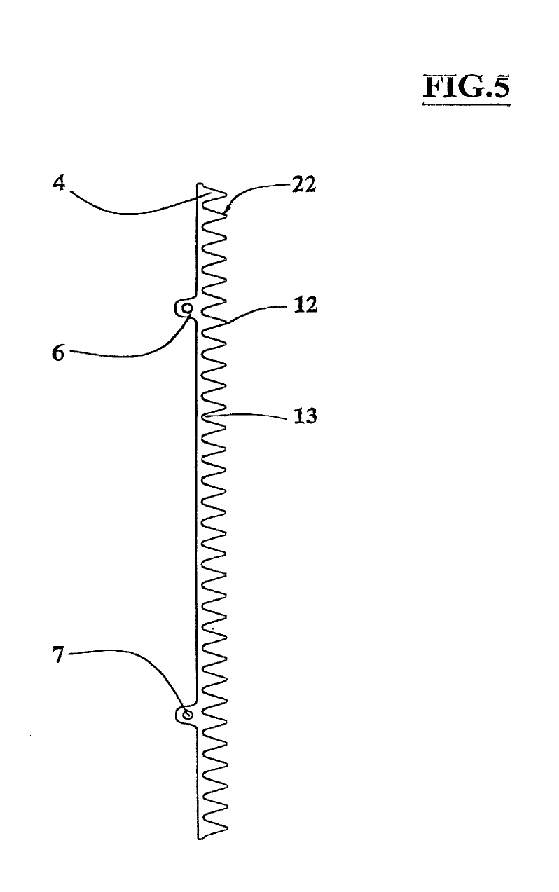

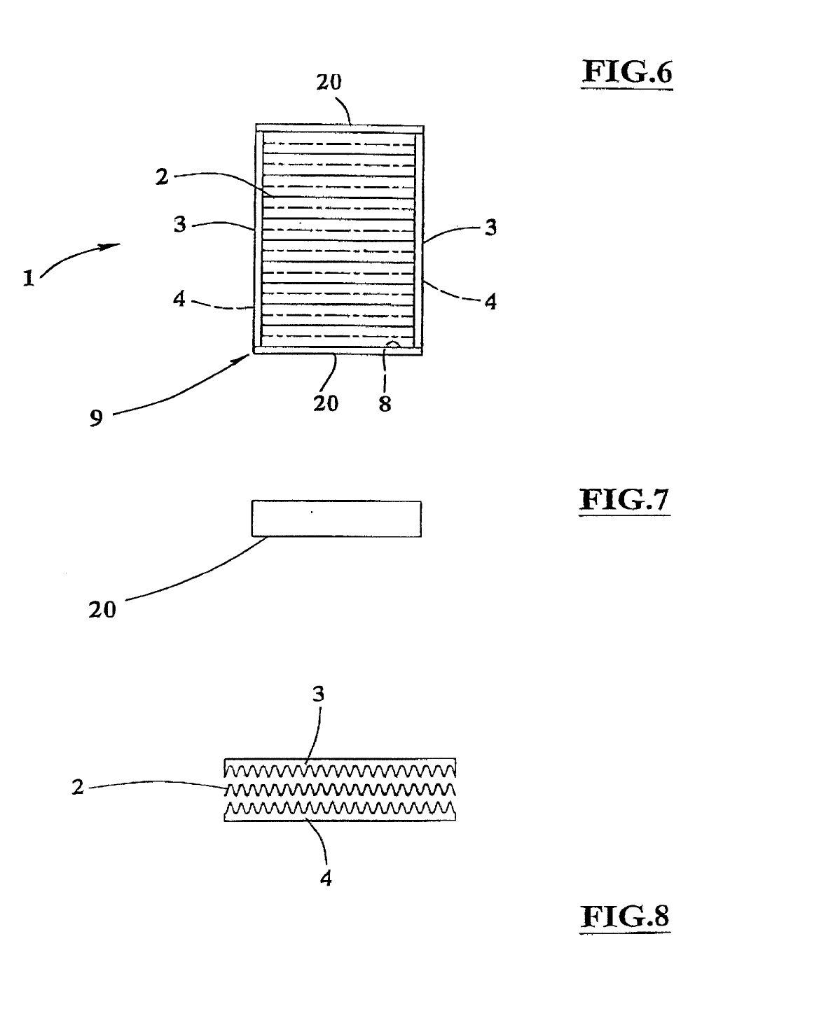

FIG. 4 shows a partial enlarged section view of a filtering element of FIG. 1;

FIG. 5 shows a side view of a second element of the FIG. 1 device;

figures from 6 to 8 show respectively plan, front and longitudinal section views of a variant of the FIG. 1 device.

With reference to figures from 1 to 5, numeral 1 indicates an enbloc device for filtering the intake air of internal combustion engines including a corrugated filtering element 2 and a supporting mean 9.

The filtering element 2 includes two net layers 14, made of metal or composite synthetic material, between which it is interposed a filtering layer 15 in synthetic or natural fibers, preferably of cotton, woven for carrying out a fabric or merged for realizing a so-called nonwoven fabric,

In an assembly condition in a single block of the device 1, the fibers of the filtering layer are soaked with low viscosity oil.

The filtering element 2 is corrugated and has parallel folds following an approximately sinusoidal or zig-zag profile with rounded vertexes and has a plan approximately reproducing the shape of a housing for the device 1, carried out in an engine intake duct.

The support mean 9 includes two annular shaped elements, first 3 and second 4, reproducing the plan perimeter of the filtering element 2 and respectively having a shaped edge, first 21 and second 22, almost complementary and reproducing, the peripheral corrugated profile of the filtering element 2.

The shaped edges, first 21 and second 22, have a plurality of rounded recesses 13 and points 12 with related bending radiuses respectively equal or bigger and equal or lower than the bending radius of the corresponding corrugated sections of the filtering element 2.

Furthermore the recesses 13 and the points 12 are filleted by nearly rectilinear sections of the respective shaped edges, first 21 and second 22, for reproducing the zig-zag profile of the filtering element 2 folds.

Said shape of the elements first 3 and second 4 allows a perfect joining between these latter and the median perimetric portion of the filtering element 2.

The elements first 3 and second 4 of the support mean 9 are made of composite material with carbon fibers, Kevlar or fiber glass in a matrix of epoxidic synthetic resin.

The enbloc fixings or assembling between the elements first 3 and second 4 of the support mean 9 with the perimetric portion of the filtering element 2 are carried out by means of a two-component adhesive 8 of polymerized epoxidic type and hardened in autoclave at controlled temperatures and pressures.

The first element 3 of the support mean 9 has a housing 10, consisting of a peripheral groove, for sealing means 11 which substantially consists of an annular gasket made of elastic, high temperature and hydrocarbon proof material, of the type so-called O-Ring.

The second element 4 of the support mean 9 has a plurality of fixing means 6, each one consisting of a protruding flange with a hole 7.

The operation of the device 1 provides that this latter is positioned in correspondence of the related housing carried out in the engine intake duct and is fixed to said housing by means of screws or pins engaged in the holes 7.

The sealing means 11 mate the walls of the device 1 housing, preferably upstream the air flow, in order to force this latter to flow totally through the filtering element 2.

The dust particles and the foreign matters carried away by the air flow are held back by the filtering layer 15 and the oil.

The variant of the device shown in the figures from 6 to 8 provides that the filtering element 2 has a plant with four rectilinear sides and that the support element 9 includes two prismatic elements 20, rectilinear with rectangular section, suitable to be enbloc fixed, by means of the two-component adhesive 8, with respective rectilinear edges of the filtering element 2.

The corrugated edges of this latter are enbloc fixed to a couple of the first elements 3 and to a couple of the second elements 4 of the support element 9. The ends of the prismatic elements 20, first 3 and second 4, are enbloc fixed.

It is important to underline that the device 1 may include a filtering element 2 with fillet section very close and therefore having an extremely wide filtering surface.

The main advantage of the present invention is to provide an enbloc device for filtering the intake air of internal combustion engines extremely strong and reliable, suitable to withstand typical mechanical stress of the race vehicles and temperatures up to about 250° C. and at the same time light and fit for reducing the air flow resistances, having a wide surface of the filtering element.

Further advantage is to provide a device without the sponge effect and having a high filtering value of the air and a low building cost and having a life not less than around 300.000 km of route covered by the vehicle on which it is installed, however usable with a minimum maintenance and having a filter easy to be disposed since mainly carried out with a natural material.

1. Enbloc device for filtering the intake air of combustion engines including a filtering element (2) corrugated and peripherally fixed to a support mean (9), said device (1) being characterized in that the support mean (9) includes at least a first element (3) and at least a second element (4) respectively having a first shaped edge (21) and a second shaped edge (22) for reproducing the peripheral profile of the filtering element (2) and fixed to this latter in single block.

2. Device according to the claim 1 characterized in that the shaped edges, first (21) and second (22), have a plurality of recesses (13) and points (12) having related bending radiuses respectively equal or greater and equal or lower than the bending radius of the corresponding corrugated sections of the filtering element (2).

3. Device according to claim 2 characterized in that the points (12) and the recesses (13) are fillet by almost rectilinear sections of the respective shaped edges, first (21) and second (22).

4. Device according co claim 1 characterized in that the elements, first (3) and second (4), of the support mean (9) are annular.

5. Device according to claim 1 characterized in that at least one of the elements, first (3) and second (4), of the support mean (9) has a housing (10) for sealing means (11).

6. Device according to claim 5 characterized in that the sealing means (11) consist of an O-Ring type gasket.

7. Device according to claim 1 characterized in that at least one of the elements, first (3) and second (4), of the support mean (9) has a plurality of fixing means (6).

8. Device according to claim 7 characterized in that each fixing mean (6) has at least a hole (7).

9. Device according to claim 1 characterized in that the support mean (9) includes a couple of prismatic elements (20) fit to be fixed in a single block with respective rectilinear edges of the filtering element (2) whose corrugated edges are enbloc fixed to two edges of the at least first element (3) and to two edges of the at least second element (4), the ends of the prismatic elements (20), first (3) and second (4). being fixed in a single block.

10. Device according to any of the preceding claims characterized in that the filtering element (2) includes two net layers (14) between which a filtering layer (15) is interposed.

11. Device according to claim 10 characterized in that the net layers (14) are made of metal or composite synthetic material and the filtering layer (15) is made of cotton fibers or natural fibers or woven or nonwoven synthetic fibers and soaked with low viscosity oil.

12. Device according to any of the preceding claims characterized in that the support mean (9) is made at least of carbon fibers or Kevlar of fiberglass in a matrix of synthetic resin.

13. Device according to any of the preceding claims characterized in that the enbloc fixings are carried out by means of a two-component adhesive (8).

14. Device according to any of the preceding claims characterized in that the fixings with two-component adhesive (8) are hardened in autoclave.
